(19) United States
(12) Patent Application Publication
(10) Pub. No.: US 2016/0222279 A1
(43) Pub. Date: Aug. 4, 2016

(54) CORROSION INHIBITOR INTENSIFIERS FOR CORROSION RESISTANT ALLOYS

(71) Applicant: Halliburton Energy Services, Inc., Houston, TX (US)

(72) Inventor: Juanita M. Cassidy, (US)

(73) Assignee: Halliburton Energy Services, Inc., Houston, TX (US)

(21) Appl. No.: 14/366,344

(22) PCT Filed: Jul. 31, 2013
(86) PCT No.: PCT/US2013/052958

§ 371 Date: Jun. 18, 2014

(51) Int. Cl. C09K 8/54; C09K 8/74; E21B 37/00; E21B 41/02; C23F 11/04; E21B 21/00

(52) U.S. Cl. CPC C09K 8/54; C23F 11/04; E21B 21/003; E21B 37/00; E21B 41/02; C09K 8/74; C09K 2208/32

(57) ABSTRACT

Corrosion inhibitor intensifiers that include a phosphonic acid, phosphonate, an ester thereof, a salt thereof, and any combination thereof may be useful in combination with corrosion inhibitors for inhibiting the corrosion for corrosion resistant alloys, and in particular, phosphonate corrosion inhibitors. In some instances, a corrosion resistant alloy that comprises at least one selected from the group consisting of chromium, nickel, copper, molybdenum, and any combination thereof may be in fluid communication with a wellhore penetrating a subterranean formation and contacted by an acidic treatment fluid comprising an aqueous base fluid, an acid, a corrosion inhibitor, and a corrosion inhibitor intensifier that comprises at least one selected from the group consisting of a phosphonic acid, phosphonate, an ester thereof, a salt thereof, and any combination thereof.

### BACKGROUND

The exemplary embodiments described herein relates to corrosion inhibitor intensifiers for corrosion resistant alloys, and in particular, phosphonate corrosion inhibitors.

During the exploration and production of hydrocarbons, corrosive environments can be encountered. The most common corrosives encountered include chloride ions, carbon dioxide, hydrogen sulfide, acids, caustics, and sulfur, each of which become more corrosive at the temperatures and pressures downhole. Corrosion can affect many downhole tools, but of most concern are the metal surfaces of conduits, mixing tanks, pumps, casing, and the like, both downhole and uphole, because of the prolonged exposure to the corrosive environments. Corrosion leads to pitting and stress corrosion cracking, and, in some instances, structural failure of the material (e.g., conduit collapse or pump failure). Further, in the case of conduits, stress cracking provides for fluid flow into the environment, contamination of the fluid within the conduit, and pressure loss in the conduit. The expense of repairing or replacing conduits and other downhole tools damaged due to corrosion is extremely high.

Corrosion resistant alloys, like HASTELLOY® (a nickel-based alloy), are often utilized for conduits and other tools where corrosion is a concern. As used herein, the term “corrosion resistant alloy” refers to the metal alloys that resist corrosion from H₂S, CO₂, brine, and combinations thereof more effectively than standard carbon steel pipe. Unlike low alloy iron-based steels, corrosion resistant alloys attain added corrosion resistance from alloying elements that are less to not soluble in acids (e.g., chromium, nickel, copper, and molybdenum). However, corrosion resistant alloys are still susceptible to corrosion, especially in acidic environments at elevated temperatures.

To combat potential corrosion problems, a variety of corrosion inhibitors have been used to reduce or prevent corrosion to downhole metals and metal alloys with varying levels of success. As used herein, the term “inhibit” and its derivatives refer to lessening the tendency of a phenomenon to occur and/or the degree to which that phenomenon occurs. The term “inhibit” does not imply any particular degree or amount of inhibition. However, corrosion inhibitors have only moderate efficacy relative to corrosion resistant alloys.

### BRIEF DESCRIPTION OF THE DRAWINGS

The following figures are included to illustrate certain aspects of the exemplary embodiments described herein, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a schematic diagram of a system that can deliver acidic treatment fluids described herein to a downhole location.

### DETAILED DESCRIPTION

The exemplary embodiments described herein relates to corrosion inhibitor intensifiers for corrosion resistant alloys, and in particular, phosphonate corrosion inhibitors.

The corrosion inhibitor intensifiers described herein may be especially suited for intensifying the erect of corrosion inhibitor in relation to corrosion resistant alloys. As used herein, the term “corrosion inhibitor intensifier” refers to compounds that are capable of enhancing the performance of a selected corrosion inhibitor.

Reducing the corrosion of corrosion resistant alloys may prolong the life-time of wellbore tools, which reduces the costs associated with repair and replacement, which can be especially high costs saving for the more expensive corrosion resistant alloys. Further, corrosion reduction mitigates the risk of severe outcomes like failure of wellbore casings.

While compositions and methods are described in terms of “comprising” various components or steps, the compositions and methods can also “consist essentially of” or “consist of” the various components and steps. When “comprising” is used in a claim, it is open-ended.

It should be noted that when “about” is provided herein at the beginning of a numerical list, “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

Some embodiments described herein may include contacting a corrosion resistant alloy with an acidic treatment fluid comprising an aqueous base fluid, an acid, a corrosion inhibitor, and a corrosion inhibitor intensifier. The corrosion resistant alloy may be disposed within a wellbore or in fluid communication with a wellbore. In some embodiments, the corrosion resistant alloy may be a portion of one of a downhole tool, a conduit, a pipe, a pipe string, a casing, a screen, a pump, a mixer, a tank, and the like, including corrosion resistant alloys in more than one of the foregoing. For example, the corrosion resistant alloy may be at least a portion of a conduit disposed, at least in part, in a wellbore penetrating a subterranean formation. In another example, the corrosion resistant alloy may be at least a portion of a conduit disposed, at least in part, above-ground and in fluid communication with a wellbore penetrating a subterranean formation.

Corrosion resistant alloys typically include at least one of chromium, nickel, copper, molybdenum, and any combination thereof. Examples of corrosion resistant alloys include, but are not limited to, 13 Cr-L80, SM13CrS-110, Carpenter 20, grades of INCONEL® (austenitic nickel-chromium-based superalloys, available from Special Metals Corporation), grades of INCOLOY® (nickel-based superalloys, available from Special Metals Corporation), grades of HASTELLOY® (nickel-based superalloys, available from Haynes International, Inc.), ULTIMET® (cobalt-based alloys, available from Haynes International, Inc.), grades of MONEL® (nickel-based alloys, available from Special Metals Corporation), and duplex stainless steels and super duplex stainless steels like a 22% chromium/5% nickel stainless steel or a 25% chromium stainless steel (stainless steels with austenite and ferrite in similar proportions, available from Langley Alloys). In some embodiments, the corrosion resistant alloy may comprise at least about 1% molybdenum (e.g., about 1% to about 10% or about 2% to about 5%).

Aqueous base fluids suitable for use in the embodiments described herein may include, but are not limited to, fresh water, saltwater (e.g., water containing one or more salts dissolved therein), brine (e.g., saturated salt water), seawater, and any combination thereof. In some embodiments, the aqueous-based fluid may further comprises aqueous-miscible fluids, which may include, but are not limited to, alcohols (e.g., methanol, ethanol, n-propanol, isopropanol, n-butanol, sec-butanol, isobutanol, and t-butanol), glycerins, glycols (e.g., polyglycols, propylene glycol, and ethylene glycol), polyglycol amines, polyols, any derivative thereof, and any combination thereof.

Further, in some instances, aqueous base fluids may be oil-in-water emulsions, where the water phase may be any of the foregoing aqueous fluids. Suitable oil phases for an oil-in-water emulsion may include, but are not limited to, an alkane, an olefin, an aromatic organic compound, a cyclic alkane, a paraffin, a diesel fluid, a mineral oil, a desulfurized hydrogenated kerosene, and any combination thereof.

Acids suitable for use in the embodiments described herein may include, but are not limited to, hydrochloric acid, hydrofluoric acid, fluoroboric acid, formic acid, acetic acid, citric acid, lactic acid, thioglycolic acid, glycolic acid, sulfamic acid, and the like, and any combination thereof.

In some instances, the amount of acid present in the acidic treatment fluid may range from a lower limit of about 1%, 2.5%, 5%, or 10% by weight of the aqueous base fluid to an upper limit of about 38%, 30%, 28%, 25%, 20%, or 15% by weight of the aqueous base fluid, and wherein the amount of acid may range from any lower limit to any upper limit and encompasses any subset therebetween.

In some instances, the acidic treatment fluid may have a pH of about 4 or less (e.g., less than 0 to about 4 including subsets thereof).

Examples of corrosion inhibitors suitable for use in the embodiments described herein may include, but are not limited to, cinnamaldehyde compound, an acetylenic compound, a condensation reaction product, a quaternized nitrogen heterocycle (e.g., quaternized quinoline and quaternized isoquinoline), and the like, and any combination thereof.

As used herein, the term “cinnamaldehyde compound” refers to cinnamaldehyde and cinnamaldehyde derivatives. Cinnamaldehyde derivatives may include any compound that may act as a source of cinnamaldehyde in mixtures encountered during use of the corrosion inhibitors. Examples of cinnamaldehyde derivatives may include, but are not limited to, dicinnamaldehyde, p-hydroxycinnamaldehyde, p-methylcinnamaldehyde, p-ethylcinnamaldehyde, p-methoxycinnamaldehyrle, p-dimethylaminocinnamaldehyde, p-diethylaminocinnamaldehyde, p-nitrocinnamaldehyde, o-nitrocinnamaldehyde, o-allyloxycinnamaldehyde, 4-(3-propenal)cinnamaldehyde, p-sodium sulfocinnamaldehyde, p-trimethylammoniumcinnamaldehyde sulfate, p-trimethylammoniumcinnamaldehyde, o-methylsulfate, p-thiocyanocinnamaldehyde, p-(S-acetyl)thiocinnamaldehyde, p-(S-N,N-dimethylcarbamoylthio)cinnamaldehyde, p-chlorocinnamaldehyde, α-methylcinnamaldehyde, β-methylcinnamaldehyde, α-chlorocinnamaldehyde, α-bromocinnamaldehyde, α-butylcinnamaldehyde, α-amylcinnamaldehyde, α-hexylcinnamaldehyde, α-bromo-p-cyanocinnamaldehyde, α-ethyl-p-methylcinnamaldehyde, p-methyl-α-pentylcinnamaldehyde, cinnamaloxime, cinnamonitrile, 5-phenyl-2,4-pentadienal, 7-phenyl-2,4,6-heptatrienal, and mixtures thereof.

Acetylenic compounds suitable for use in embodiments described herein may include acetylenic alcohols such as, for example, acetylenic compounds having the general formula: R₇C≡C-CR₈R₉OH wherein R7, R8, and R9 are individually selected from the group consisting of hydrogen, alkyl, phenyl, substituted phenyl hydroxy-alkyl radicals. In certain embodiments, R7 comprises hydrogen. In certain embodiments, R8 comprises hydrogen, methyl, ethyl, or propyl radicals. In certain embodiments, R9 comprises an alkyl radical having the general formula CₙH₂ₙ, where n is an integer from 1 to 10. In certain embodiments, the acetylenic compound R₇CCCR₈R₉OR₁₀ may also be used where R10 is a hydroxy-alkyl radical. Examples of acetylenic alcohols suitable for use in the exemplary embodiments described herein include, but are not limited to, methyl butynol, methyl pentynol, hexynol, ethyl octynol, propargyl alcohol, benzylbutynol, ethynylcyclohexanol, ethoxy acetylenics, propoxy acetylenics, and mixtures thereof.

As used herein, a “condensation reaction product” includes the reaction product of effective amounts of one or more active hydrogen containing compounds with one or more organic carbonyl compound having at least one hydrogen atom on the carbon atom alpha to the carbonyl group and a fatty acid or other fatty compound or alkyl nitrogen heterocycles and preferably 2 or 4 alkyl substituted and an aldehyde, and, in certain embodiments, those aldehydes that may comprise aliphatic aldehydes containing from 1 to 16 carbons and aromatic aldehydes having no functional groups that are reactive under the reaction conditions other than aldehydes. The above ingredients may be reacted in the presence of an acid catalyst of sufficient strength to thereby form the reaction product. These condensation reaction products are described in more detail in U.S. Pat. No. 5,366,643, the entire disclosure of which is hereby incorporated by reference.

In some instances, the amount of corrosion inhibitors present in the acidic treatment fluid may range from a lower limit of about 0.05%, or 0.5% by volume of the aqueous base fluid to an upper limit of about 5%, 3%, 2%, or 1% by volume of the aqueous base fluid, and wherein the amount of corrosion inhibitors may range from any lower limit to any upper limit and encompasses any subset therebetween.

Corrosion inhibitor intensifiers suitable for use in the embodiments described herein may, in some embodiments, be phosphonic acids, phosphonates, esters thereof, salts thereof, and any combination thereof.

In some instances, corrosion inhibitor intensifiers may have a general formula according to Formula I, wherein R1, R2 and R3 are independently selected from hydrogen, alkyl, aryl, phosphonic, phosphonate, phosphate, aminophosphonic acid, aminophosphonate, acyl, amine, hydroxyl, alkyl carboxyl, or carboxyl groups or R4 and R5 are independently selected from hydroyen, sodium, potassium, ammonium or an organic radical.

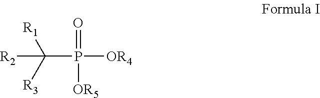

Examples of corrosion inhibitor intensifiers may include, but are not limited to, amino trimethylene phosphonic acid, bis(hexa methylene triamine penta (methylene phosphonic acid), diethylene triamine penta(methylene phosphonic acid), ethylene diamine tetra(methylene phosphonic acid), hexamethylenediamine tetra(methylene phosphoric acid), 1-hydroxy ethylidene-1,1-diphosphonic acid, 2-hydroxyphosphonocarboxylic acid, 2-phosphonobutane-1,2,4-tricarboxylic acid, methylene diphosphonic acid, derivatives thereof, salts thereof (e.g., sodium, potassium, ammonium, or organic radical salts), and any combination thereof.

In some instances, the amount of corrosion inhibitor intensifiers present in the acidic treatment fluid may range from a lower limit of about 0.1%, 0.5%, 1%, or 2% by weight of the aqueous base fluid to an upper limit of about 6%, 5%, or 3% by weight of the aqueous base fluid, and wherein the amount of corrosion inhibitor intensifiers may range from any lower limit to any upper limit and encompasses any subset therebetween. It should be noted that the concentration of corrosion inhibitor intensifiers provided herein are based on the amount of active component and do not include a fluid that the active component may be suspended or dissolved in. One of ordinary skill in the art, with the benefit of this disclosure, will recognize the concentrations of corrosion inhibitor intensifiers may fall outside these preferred ranges. For example, corrosion inhibitor intensifiers may be present in the acidic treatment fluid in an amount of about 15%, or greater, by weight of the aqueous base fluid. However, in some instances, depending on the corrosion inhibitor intensifiers, concentrations outside these preferred ranges may provide marginal increases in corrosion inhibition.

In some embodiments, the acidic treatment fluid described herein may decrease corrosion of the corrosion resistant alloy at least about 10% less than a comparable acidic treatment fluid not comprising the corrosion inhibitor intensifier when tested by the Corrosion Assessment Procedure described herein. For example, the corrosion resistant alloy may corrode at least about 10% to about 150% less than a comparable acidic treatment fluid when tested by the Corrosion Assessment Procedure described herein. As used herein, the “Corrosion Assessment Procedure” refers to a procedure of (1) exposing a corrosion resistant alloy (prepared by degreasing with acetone and beadblasting) to a test fluid (e.g., 15% hydrochloric acid/10% acetic acid) for 15 hours at 180° F. (82° C.) (including heat up and cool down time) and 1000 psi and (2) measuring the weight loss of the corrosion resistant alloy. The comparative percentage may be calculated by (mass loss in comparable acidic treatment fluid-mass loss in acidic treatment fluid)/(mass loss in comparable acidic treatment fluid).

In some instances, the acidic treatment fluid described herein may further comprise other additives. Examples of such additives may include, but are not limited to, salts, weighting agents, fluid loss control agents, emulsifiers, dispersion aids, emulsion thinners, emulsion thickeners, viscosifying agents, gelling agents, surfactants, foaming agents, gases, pH control additives, breakers, crosslinkers, stabilizers, chelating agents, scale inhibitors, gas hydrate inhibitors, mutual solvents, oxidizers, reducers, friction reducers, clay stabilizing agents, and the like, and any combination thereof. One of ordinary skill in the art, with the benefit of this disclosure, should recognize the appropriate concentration and composition of individual additives so as to minimally, if at all, affect the performance of the corrosion inhibitor intensifiers described herein.

Some embodiments may involve contacting a corrosion resistant alloy with an acidic treatment fluid described herein; and introducing the acidic treatment fluid into a wellbore penetrating a subterranean formation. The acidic treatment fluids described herein may be useful in a plurality of subterranean operations (e.g., drilling operations, stimulation operations, and completion operations) where the acidic treatment fluid contacts a corrosion resistant alloy, which as described herein may be disposed in the wellbore (e.g., a pipe string, downhole tool, or screen) or fluidly connected to the wellbore (e.g., a pump or a mixer).

By way of nonlimiting example, the acidic treatment fluids described herein may be utilized in acidizing treatments where the acidic treatment fluid contacts a corrosion resistant alloy. Some embodiments may involve contacting a corrosion resistant alloy with an acidic treatment fluid described herein; and introducing the acidic treatment fluid into a wellbore penetrating a subterranean formation pressure at a pressure below that required to create or extend at least one fracture in the subterranean formation. It is believed that the acidic treatment fluid flows into the fractures, microfractures, and pore spaces of the formation and reacts with the acid-soluble materials therein, which enlarges the fractures, microfractures, and pore spaces and increases the permeability of the formation. The flow of hydrocarbons from the formation is, therefore, increased because of the increase in formation conductivity.

In another example, the acidic treatment fluids described herein may be useful in acid-fracturing treatments. Some embodiments may involve contacting a corrosion resistant alloy with an acidic treatment fluid described herein; introducing the acidic treatment fluid into a wellbore penetrating a subterranean formation at or above a pressure required to create or extend at least one fracture in the subterranean formation; and creating at least one channel in the subterranean formation proximal to the at least one fracture. It is believed that the acidic treatment fluid creates channels in the subterranean formation proximal to the at least one fracture such that when the pressure is reduced and the fracture closes, the channels provide for fluid flow through the subterranean formation.

In yet another example, the acidic treatment fluids described herein may be useful in perforation breakdown. Some embodiments may involve contacting a corrosion resistant alloy with an acidic treatment fluid described herein; introducing the acidic treatment fluid into a wellbore penetrating a subterranean formation, wherein the wellbore or the subterranean formation includes at least one perforation have a diminished fluid flow therethrough; and contacting the at least one perforation with the acidic treatment fluid so as to increase the fluid flow therethrough.

In another example, the acidic treatment fluid may be useful in degrading filter cakes in a wellbore. Some embodiments may involve contacting a corrosion resistant alloy with an acidic treatment fluid described herein; and contacting a filter cake in a wellbore penetrating a subterranean formation with the acidic treatment fluid so as to degrade at least a portion of the filter cake. In some instances, the terms “degradation” or “degradable” refer to the conversion of materials into smaller components, intermediates, or end products by the result of solubilization, hydrolytic degradation, biologically formed entities (e.g., bacteria or enzymes), chemical reactions, thermal reactions, reactions induced by radiation, or any other suitable mechanism.

In yet another example, the acidic treatment fluid may be useful for breaking other fluids. Some embodiments may involve contacting a corrosion resistant alloy with an acidic treatment fluid described herein; and contacting a viscosified fluid in a wellbore penetrating a subterranean formation with the acidic treatment fluid so as to decrease the viscosity of the viscosified fluid. In some instances, the viscosified fluid may be in the subterranean formation or both the wellbore and the subterranean formation.

In various embodiments, systems configured for delivering the treatment fluids described herein to a downhole location are described. In various embodiments, the systems can comprise a pump fluidly coupled to a tubular, the tubular containing an acidic treatment fluid comprising an aqueous base fluid, an acid, a corrosion inhibitor, and a corrosion inhibitor intensifier, the corrosion inhibitor intensifier comprising at least one selected from the group consisting of a phosphonic acid, phosphonate, an ester thereof, a salt thereof, and any combination thereof.

The pump may be a high pressure pump in some embodiments. As used herein, the term “high pressure pump” will refer to a pump that is capable of delivering a fluid downhole at a pressure of about 1000 psi or greater.

A high pressure pump may be used when it is desired to introduce the acidic treatment fluid to a subterranean formation at or above a fracture gradient of the subterranean formation, but it may also be used in cases where fracturing is not desired. In some embodiments, the high pressure pump may be capable of fluidly conveying particulate matter, such as proppant particulates, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the acidic treatment fluid to the high pressure pump. In such embodiments, the low pressure pump may “step up” the pressure of the acidic treatment fluid before it reaches the high pressure pump.

In some embodiments, the systems described herein can further comprise a mixing tank that is upstream of the pump and in which the acidic treatment fluid is formulated. In various embodiments, the pump (e.g., a low pressure pump, a high pressure pump, or a combination thereof) may convey the acidic treatment fluid from the mixing tank or other source of the acidic treatment fluid to the tubular. In other embodiments, however, the acidic treatment fluid can be formulated offsite and transported to a worksite, in which case the acidic treatment fluid may be introduced to the tubular via the pump directly from its shipping container (e.g., a truck, a railcar, a barge, or the like) or from a transport pipeline. In either case, the acidic treatment fluid may be drawn into the pump, elevated to an appropriate pressure, and then introduced into the tubular for delivery downhole.

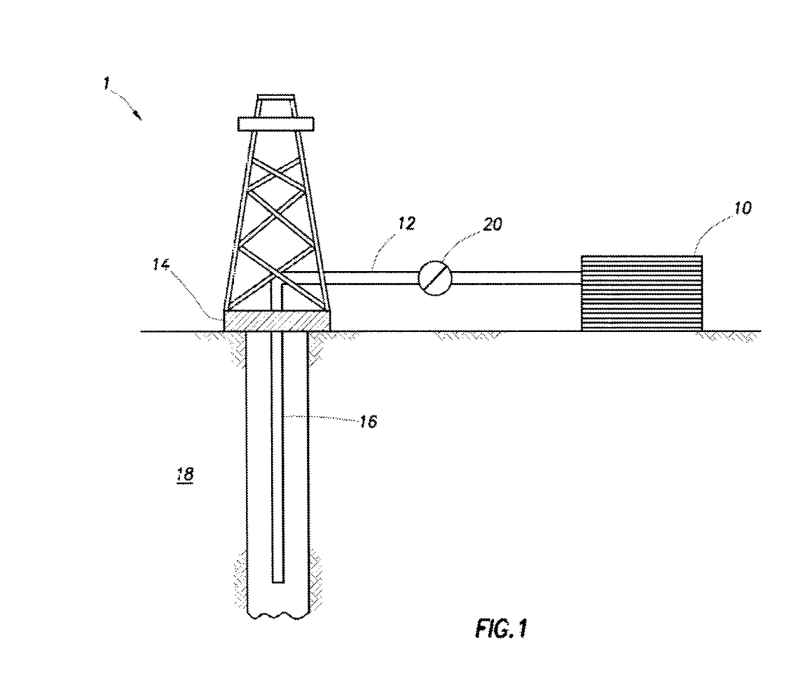

FIG. 1 shows an illustrative schematic of a system that can deliver acidic treatment fluids described herein to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which an acidic treatment fluid described herein may be formulated. The acidic treatment fluid may be conveyed via line 12 to wellhead 14, where the acidic treatment fluid enters tubular 16, tubular 16 extending from wellhead 14 into subterranean formation 18. Upon being ejected from tubular 16, the acidic treatment fluid may subsequently penetrate into subterranean formation 18. Pump 20 may be configured to raise the pressure of the acidic treatment fluid to a desired degree before its introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the acidic treatment fluid may, in some embodiments, flow back to wellhead 14 and exit subterranean formation 18. In some embodiments, the acidic treatment fluid that has flowed back to wellhead 14 may subsequently be recovered and recirculated to subterranean formation 18.

It is also to be recognized that the disclosed acidic treatment fluids may also directly or indirectly affect the various downhole equipment and tools that may come into contact with the acidic treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

Embodiments disclosed herein include, but are not limited to:
A. a method that includes providing a corrosion resistant alloy that comprises at least one selected from the group consisting of chromium, nickel, copper, molybdenum, and any combination thereof, wherein the corrosion resistant alloy is in fluid communication with a wellbore penetrating a subterranean formation; and contacting the corrosion resistant alloy with an acidic treatment fluid comprising an aqueous base fluid, an acid, a corrosion inhibitor, and a corrosion inhibitor intensifier, the corrosion inhibitor intensifier comprising at least one selected from the group consisting of a phosphonic acid, phosphonate, an ester thereof, a salt thereof, and any combination thereof;
B. a method that includes providing a corrosion resistant alloy that comprises at least one selected from the group consisting of chromium, nickel, copper, molybdenum, and any combination thereof, wherein the corrosion resistant alloy is in fluid communication with a wellbore penetrating a subterranean formation; contacting the corrosion resistant alloy with an acidic treatment fluid comprising an aqueous base fluid, an acid, a corrosion inhibitor, and a corrosion inhibitor intensifier, the corrosion inhibitor intensifier comprising at least one selected from the group consisting of a phosphonic acid, phosphonate, an ester thereof, a salt thereof, and any combination thereof; and wherein the acidic treatment fluid corrodes the corrosion resistant alloy less than a comparable acidic treatment fluid not comprising the corrosion inhibitor intensifier by about 10% or greater; and
C. a method that includes providing a corrosion resistant alloy that comprises at least about 1% molybdenum, wherein the corrosion resistant alloy is in fluid communication with a wellbore penetrating a subterranean formation; contacting the corrosion resistant alloy with an acidic treatment fluid having a pH of about 4 or less and comprising an aqueous base fluid, an acid, a corrosion inhibitor, and a corrosion inhibitor intensifier, the corrosion inhibitor intensifier comprising at least one selected from the group consisting of a phosphonate, an ester thereof, a salt thereof, and any combination thereof; and wherein the acidic treatment fluid corrodes the corrosion resistant alloy less than a comparable acidic treatment fluid not comprising the corrosion inhibitor intensifier by about 25% or greater.

Each of embodiments A, B, and C may have one or more of the following additional elements in any combination unless otherwise provided for: Element 1: the acidic treatment fluid corroding the corrosion resistant alloy less than a comparable acidic treatment fluid not comprising the corrosion inhibitor intensifier by about 10% or greater; Element 2: the acidic treatment fluid corroding the corrosion resistant alloy less than a comparable treatment fluid not comprising the corrosion inhibitor intensifier by about 25% or greater; Element 3: the corrosion resistant alloy comprises at least about 1% molybdenum; Element 4: the corrosion inhibitor intensifier comprises at least one selected from the group consisting of amino trimethylene phosphonic acid, bis(hexa methylene triamine penta (methylene phosphonic acid), diethylene triamine penta(methylene phosphonic acid), ethylene diamine tetra(methylene phosphonic acid), hexamethylenediamine tetra(methylene phosphonic acid), 1-hydroxy ethylidene-1,1-diphosphonic acid, 2-hydroxyphosphonocarboxylic acid, 2-phosphonobutane-1,2,4-tricarboxylic acid, methylene diphosphonic acid, a derivative thereof, a salt thereof, and any combination thereof; Element 5: the corrosion inhibitor intensifier comprising a compound according to Formula I, wherein R1, R2 and R3 are independently selected from hydrogen, alkyl, aryl, phosphonic, phosphonate, phosphate, aminophosphonic acid, aminophosphonate, acyl, amine, hydroxyl, alkylcarboxyl, or carboxyl groups or R4 and R5 are independently selected from hydrogen, sodium, potassium, ammonium or an organic radical

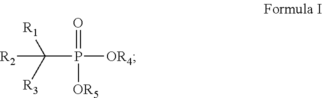

Element 6: the corrosion inhibitor intensifier being present in an amount of about 0.1% to about 6% by volume of the aqueous base fluid; Element 7: the acid comprising at least one selected from the group consisting of hydrochloric acid, hydrofluoric acid, fluoroboric acid, formic acid, acetic acid, citric acid, lactic acid, thioglycolic acid, glycolic acid, sulfamic acid, and any combination thereof; Element 8: the acidic treatment fluid having a pH of about 4 or less; Element 9: the acid being present in an amount of about 1% to about 38% by weight of the aqueous base fluid; Element 10: the corrosion resistant alloy being at least a portion of a conduit disposed within a wellbore penetrating a subterranean formation; Element 11: the corrosion resistant alloy being at least a portion of a pump; Element 12: the corrosion resistant alloy being at least a portion of a wellbore tool; Element 13: the method further including introducing the acidic treatment fluid into a wellbore penetrating a subterranean formation pressure at a pressure below that required to create or extend at least one fracture in the subterranean formation; Element 14: the method further including introducing the acidic treatment fluid into a wellbore penetrating a subterranean formation pressure at or above a pressure sufficient create or extend at least one fracture in the subterranean formation and creating at least one channel in the subterranean formation proximal to the at least one fracture; Element 15: the method further including contacting a filter cake in a wellbore penetrating a subterranean formation with the acidic treatment fluid so as to degrade at least a portion of the filter cake; Element 16: the method further including contacting a viscosified fluid in a wellbore penetrating a subterranean formation with the acidic treatment fluid so as to decrease the viscosity of the viscosified fluid.

By way of non-limiting example, exemplary combinations applicable to A, B, C include: one of Elements 4-5 in combination with at least one of Elements 7-9; Element 3 in combination with any of the foregoing; one of Elements 1-2 in combination with any of the foregoing; one of Elements 12-16 in combination with any of the foregoing; at least one of Elements 10-12 in combination with any of the foregoing; and so on.

Some embodiments may be a system comprising a pump fluidly coupled to a tubular; wherein the tubular contains an acidic treatment fluid comprising an aqueous base fluid, an acid, a corrosion inhibitor, and a corrosion inhibitor intensifier, the corrosion inhibitor intensifier comprising at least one selected from the group consisting of a phosphonic acid, phosphonate, an ester thereof, a salt thereof, and any combination thereof; and wherein at portion of the system in contact with the acidic treatment fluid comprises a corrosion resistant alloy that comprises at least one selected from the group consisting of chromium, nickel, copper, molybdenum, and any combination thereof. In some instances, the acidic treatment fluid may include at least one of Elements 1-9 above. In some instances, the portion of the system that comprises the corrosion resistant allow may include at least one of Elements 10-12. Combinations of the foregoing may also be applicable.

One or more illustrative embodiments incorporating the invention disclosed herein are presented herein. Not all features of an actual implementation are described or shown in this application for the sake of clarity. It is understood that in the development of an actual embodiment incorporating the embodiments described herein, numerous implementation-specific decisions must be made to achieve the developer's goals, such as compliance with system-related, business-related, government-related and other constraints, which vary by implementation and from time to time. While a developer's efforts might be complex and time-consuming, such efforts would be, nevertheless, a routine undertaking for those of ordinary skill the art having benefit of this disclosure.

To facilitate a better understanding of the exemplary embodiments described herein, the following examples of preferred or representative embodiments are given. In no way should the following examples be read to limit, or to define, the scope of the invention.

### EXAMPLES

Corrosion testing was performed using the weight loss method. Weight loss corrosion testing was performed in individual HASTELLOY B-2 autoclaves. 100 mL of the test fluids was placed into a glass cell, followed by introduction of the test pieces of metal, which were prepared by degreasing with acetone and beadblasting. After capping the glass cell, the remaining autoclave volume was filled with kerosene and cell contents are pressurized to 1000 psi. Heating was accomplished using Eurotherm heaters. Pressure was maintained using a back pressure regulator assembly which allows for automatic bleed off of excess pressure developed during heating and corrosion. Test times were contact times and included heat up and cool down.

### Example 1

An acidic fluid was prepared with 7.5% HCl, 10% acetic acid, 2% HAI-404M™ (a corrosion inhibitor, available from Halliburton Energy Services, Inc.), 50 lb/Mgal (pounds per thousand gallons) Fe-2 (an iron sequestering agent, available from Halliburton Energy Services, Inc.), 20 lb/Mgal FERCHECK® A (a ferric iron inhibitor, available from Halliburton Energy Services, Inc.), 5% MUSOL® E (a mutual solvent, available from Halliburton Energy Services, Inc.), 1.2% AS-11a® (an anti-sludging agent, available from Halliburton Energy Services), 1.5% AS-11e® (an anti-sludging agent, available from Halliburton Energy Services), 0.5% LOSURF® 300M (a surfactant, available from Halliburton Energy Services, Inc.), 0.3% PEN-88HT (a surfactant, available from Halliburton Energy Services, Inc.), 2% HII-500M (a corrosion inhibitor, available from Halliburton Energy Services, Inc.), and 24 lb/Mgal ammonium bifluoride.

Three test fluids were prepared in the foregoing acidic fluid with (1) no corrosion inhibitor intensifiers described herein, (2) 5% EC6079A® (10-30% sodium diethylene triaminepenta (methylene phosphonate), available from Nalco), and (3) 5% LP-65® (an organic phosphonate blend, available from Halliburton Energy Services, Inc.).

Pieces of N-80 low alloy steel (not a corrosion resistant alloy) were immersed in the test fluids for 4 hours at 300° F. (149° C.) at 1000 psi. The steel exposed to the control test fluid with no corrosion inhibitor intensifier described herein lost 0.007 lb/ft², while the test fluids (2) and (3) with corrosion inhibitor intensifier described herein lead to weight loss of 0.192 lb/ft² and 0.131 lb/ft², respectively. This shows that corrosion inhibitor intensifier used in embodiments described herein may cause additional corrosion when used with at least some non-corrosion resistant alloys. Whereas when used with corrosion resistant alloys, the corrosion inhibitor intensifier used in embodiments described herein exhibit enhanced corrosion resistance.

### Example 2

An acidic fluid was prepared with 15% HCl, 10% acetic acid, 9% PARAGON™ solvent (a xylene solvent, available from Halliburton Energy Services, Inc.), 1% WS-36® (a dispersant, available from Halliburton Energy Services, Inc.), 8.73 pounds per gallon (ppg) potassium chloride, 25 lb/Mgal FERCHECK® A (a ferric iron inhibitor, available from Halliburton Energy Services, Inc.), 1% AS-10® (an anti-sludging agent, available from Halliburton Energy Services), and 1% HAI-404M® (a corrosion inhibitor, available from Halliburton Energy Services, Inc.).

Two test fluids were prepared in the foregoing acidic fluid with (1) 5% EC6079A® and (2) no corrosion inhibitor intensifiers described herein.

Pieces of Carpenter 20 alloy and 13Cr-L80 alloy (both being corrosion resistant alloys) were immersed in the test fluids for 15.5 hours at 180° F. (82° C.). Table 1 provides the weight loss for the various tests.

TABLE 1

| | | Weight | Average Wt |
|---|---|---|---|
| Alloy | Test Fluid | Loss (g) | Loss (g) |
| Carpenter 20 | (1) EC6079A ® | 0.003 | 0.006 |
| Carpenter 20 | (1) EC6079A ® | 0.008 | |
| Carpenter 20 | (2) control | 0.023 | 0.018 |
| Carpenter 20 | (2) control ® | 0.013 | |
| 13Cr-L80 | (1) EC6079A ® | 0.021 | 0.020 |
| 13Cr-L80 | (1) EC6079A ® | 0.018 | |
| 13Cr-L80 | (2) control | 0.024 | 0.024 |
| 13Cr-L80 | (2) control ® | 0.024 | |

Using the corrosion inhibitor intensifier reduced the amount of corrosion by 66% for the Carpenter 20 alloy and by 12% for the 13Cr-L80 alloy.

### Example 3

An acidic fluid was prepared with 10% formic acid, 5 wt% ammonium chloride, 2% MSA-III (a corrosion inhibitor, available from Halliburton Energy Services, Inc.), and 60 lb/Mgal HII-124B (a corrosion inhibitor, available from Halliburton Energy Services, Inc.).

Two test fluids were prepared in the foregoing acidic fluid with (1) no corrosion inhibitor intensifiers described herein and (2) 10% LP-65®.

Pieces of SM13CrS-110 alloy (a corrosion resistant alloy) were immersed in the test fluids for 24 hours at 280° F. (138° C.). The SM13CrS-110 alloy exposed to the control test fluid with no corrosion inhibitor intensifier described herein lost 0.132 lb/ft², while the test fluid with corrosion inhibitor intensifier described herein lead to (in two separate tests) weight loss of 0.049 lb/ft² and 0.031 lb/ft², respectively. Therefore, using the corrosion inhibitor intensifier reduced the amount of corrosion by about 70% for the SM13CrS-110 alloy.

### Example 4

An acidic fluid was prepared with 15% hydrochloric acid, 2% HAI-404M (a corrosion inhibitor, available from Halliburton Energy Services, Inc.), and 10% LP-65®.

Pieces of 303 stainless steel (303 SS) (a moderately corrosion resistant alloy) and 316 SS (a corrosion resistant alloy) were immersed in the acidic fluid for 4 hours at 300° F. (149° C.). The 303 SS exposed to the acidic fluid lost 0.524 lb/ft², while the 316 SS lost 0.016 lb/ft². Without being limited by theory, it is believed that the molybdenum alloyed in 316 SS (about 2-3% in 316 SS and none in 303SS) may further enhance the efficacy of the corrosion inhibitor intensifier. This is further evidenced in that Carpenter 20 and SM13CrS-110 both also include about 2%-3% alloyed molybdenum.

Therefore, the exemplary embodiments described herein are well adapted to attain the ends and advantages mentioned as well as those that are inherent therein. The particular embodiments disclosed above are illustrative only, as the exemplary embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the exemplary embodiments described herein. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

1-12. (canceled)

13. A method comprising:
providing a corrosion resistant alloy that comprises at least one selected from the group consisting of chromium, nickel, copper, molybdenum, and any combination thereof, wherein the corrosion resistant alloy is in fluid communication with a wellbore penetrating a subterranean formation; and
contacting the corrosion resistant alloy with an acidic treatment fluid comprising an aqueous base fluid, an acid, a corrosion inhibitor, and a corrosion inhibitor intensifier, the corrosion inhibitor intensifier comprising at least one selected from the group consisting of a phosphonic acid, phosphonate, an ester thereof, a salt thereof, and any combination thereof,
wherein the acidic treatment fluid corrodes the corrosion resistant alloy less than a comparable acidic treatment fluid not comprising the corrosion inhibitor intensifier by about 10% or greater, and
contacting a filter cake in a wellbore penetrating a subterranean formation with the acidic treatment fluid so as to degrade at least a portion of the filter cake.

14. A method comprising:
providing a corrosion resistant alloy that comprises at least one selected from the group consisting of chromium, nickel, copper, molybdenum, and any combination thereof, wherein the corrosion resistant alloy is in fluid communication with a wellbore penetrating a subterranean formation; and
contacting the corrosion resistant alloy with an acidic treatment fluid comprising an aqueous base fluid, an acid, a corrosion inhibitor, and a corrosion inhibitor intensifier, the corrosion inhibitor intensifier comprising at least one selected from the group consisting of a phosphonic acid, phosphonate, an ester thereof, a salt thereof, and any combination thereof,
wherein the acidic treatment fluid corrodes the corrosion resistant alloy less than a comparable acidic treatment fluid not comprising the corrosion inhibitor intensifier by about 10% or greater, and
contacting a viscosified fluid in a wellbore penetrating a subterranean formation with the acidic treatment fluid so as to decrease the viscosity of the viscosified fluid.

15. A method comprising:
providing a corrosion resistant alloy that comprises at least one selected from the group consisting of chromium, nickel, copper, molybdenum, and any combination thereof, wherein the corrosion resistant alloy is in fluid communication with a wellbore penetrating a subterranean formation;
contacting the corrosion resistant alloy with an acidic treatment fluid comprising an aqueous base fluid, an acid, a corrosion inhibitor, and a corrosion inhibitor intensifier, the corrosion inhibitor intensifier comprising at least one selected from the group consisting of a phosphonic acid, phosphonate, an ester thereof, a salt thereof, and any combination thereof; and
wherein the acidic treatment fluid corrodes the corrosion resistant alloy less than a comparable acidic treatment fluid not comprising the corrosion inhibitor intensifier by about 10% or greater; and,
wherein the corrosion inhibitor intensifier comprises a compound according to Formula I, wherein R1, R2 and R3 are independently selected from hydrogen, alkyl, aryl, phosphonic, phosphonate, phosphate, aminophosphonic acid, aminophosphonate, acyl, amine, hydroxyl, alkylcarboxyl, or carboxyl groups or R4 and R5 are independently selected from hydrogen, sodium, potassium, ammonium or an organic radical

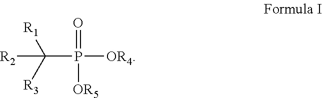

16. The method of claim 15 further comprising:
introducing the acidic treatment fluid into the wellbore penetrating the subterranean formation pressure at a pressure below that required to create or extend at least one fracture in the subterranean formation.

17. The method of claim 15 further comprising:
contacting a filter cake in the wellbore with the acidic treatment fluid so as to degrade at least a portion of the filter cake.

18. The method of claim 15 further comprising:
contacting a viscosified fluid in the wellbore with the acidic treatment fluid so as to decrease the viscosity of the viscosified fluid.

19. (canceled)
